(19) United States
(12) Patent Application Publication
(10) Pub. No.: US 2025/0326040 A1
(43) Pub. Date: Oct. 23, 2025

(54) Quick-Change Shell Mill

(71) Applicant: Kennametal Inc., Latrobe, PA (US)

(72) Inventor: Joshua C. Smith, Latrobe, PA (US)

(73) Assignee: Kennametal Inc., Latrobe, PA (US)

(21) Appl. No.: 18/640,308

(22) Filed: Apr. 19, 2024

(51) Int. Cl. B23C 5/26; B23C 5/08

(52) U.S. Cl. CPC B23C 5/26; B23C 5/08

(57) ABSTRACT

A cutting tool includes a cutter disc, a cutter base adapted to be attached to an arbor, a fastener, and a plate. The cutter disc includes at least one cutting surface on each of a top and a bottom side thereof. The fastener extends through the cutter base and removably secures the cutter disc to the cutter base in each of a first position and a second position exposing a respective one of the top and bottom sides of the cutter disc for use. The plate is mounted to the cutter base between the cutter disc and the cutter base, and fixes a position of the fastener.

### FIELD OF THE INVENTION

The present disclosure relates to cutting tools, and more specifically, to a shell mill.

### BACKGROUND

In the field of machining, a shell mill is any of various modular milling cutters (e.g., a face mill or an endmill), with the shank or arbor therefore made separately from a body (or “shell”) of the tool and attached thereto via any number of methods. For example, FIG. 22 illustrates a common shell mill arbor or adapter 400. In this example, a shell mill or milling cutter would be attached to the adapter 400 via its internal threaded opening 410. The cutter or shell mill may include one or more cutting surfaces, often defined by replaceable cutting inserts.

Shell mills have several advantages of over single piece or fully integrated milling cutters, including ease of manufacturing, as well as the ability to replace only individual components of the tool assembly. As a result, modular shell mills are commonly used for large milling cutters Despite their inherent advantages, during industrial production significant time is still spent removing these often large cutters and their associated adapters out of the machine (e.g., a CNC machine's spindle), and indexing their cutting inserts (e.g., replacing and accurately positioning the inserts) when required. This downtime reduces overall production efficiency, and therefore should be minimized.

### SUMMARY

According to an embodiment of the present disclosure, a cutting tool includes a cutter disc, a cutter body adapted to be attached to an arbor, a fastener, and a plate. The cutter disc includes at least one cutting surface on each of top and bottom sides thereof. The fastener extends through the cutter body and removably secures the cutter disc to the cutter body in each of a first position and a second position exposing a respective one of the top and bottom sides of the cutter disc for use. The plate is mounted to the cutter body between the cutter plate and the cutter body, and fixes a position of the fastener.

### BRIEF DESCRIPTION OF THE DRAWINGS

The invention will now be described by way of example with reference to the accompanying Figures, of which:

FIG. 1 is a top/side perspective view of a shell mill or cutting tool according to an embodiment of the present disclosure;

FIG. 2 is a bottom/side perspective view of the tool of the present disclosure;

FIG. 3 is a cross-sectional perspective view of the tool of the present disclosure;

FIG. 4 is a cross-sectional perspective view of a double or dual action bolt used in the tool of the present disclosure;

FIG. 5 is a partial exploded view of components of the tool of the present disclosure;

FIG. 6 is a partial exploded view of components of the tool of the present disclosure;

FIG. 7 is an assembled view of components of the tool of the present disclosure;

FIG. 8 is an exploded view of the tool of the present disclosure;

FIG. 9 is a perspective view of the tool of the present disclosure in a state of being assembled or disassembled;

FIGS. 10, 11 and 12 are each side views illustrating a maintenance operation of the tool of the present disclosure;

FIG. 13 is another perspective view of the tool of the present disclosure in a state of being assembled or disassembled;

FIG. 14 is a perspective view of a tool useful for removing a cutter disc of the tool of the present disclosure;

FIG. 15 is a top and/or bottom view of the cutter disc according to an embodiment of the present disclosure;

FIG. 16 is a partial side perspective view of the cutter disc of FIG. 15 with a cutting insert thereof removed;

FIG. 17 is a side perspective view of a cutting insert useful in the tool of the present disclosure;

FIG. 18 is a partial perspective view of the cutting insert being installed into the cutter disc of the tool of the present disclosure;

FIG. 19 is a perspective view of a fastener used to install the cutting insert of FIG. 17;

FIG. 20 is a side view of a cutting insert useful in the tool of the present disclosure;

FIG. 21 is a side view illustrating the cutting symmetry of the cutter disc according to embodiments of the present disclosure; and

FIG. 22 is a perspective view of a shell mill adapter or arbor according to the prior art, which may be mated to the tool of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to one embodiment of the present disclosure, a shell mill includes a cutter embodied as a cutter disc having a plurality of cutting inserts fixed thereto. Each of the inserts has two edges that are opposite handed of each other, with each edge extending from an opposite side of the cutter disc. The opposite edges of each insert define cutting surfaces on each side of the disc, both of which may be identical to one another. The cutter disc is adapted to be operated in each of two orientations on a base of the shell mill, such that when one side of the cutter disc is worn, by way of example, it may be quickly rotated or flipped on the base, and the other side utilized in its place. In this way, it is faster to index one piece of the shell mill rather than indexing all of the inserts, or insert edges, which would be required via traditional insert replacement.

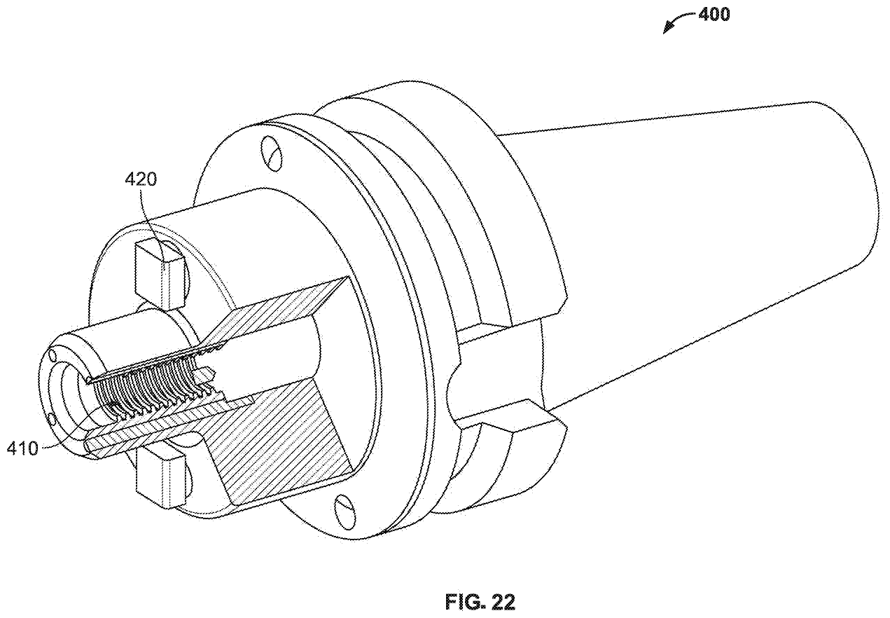

The shell mill further includes a cutter base through which a double or dual action bolt or fastener is passed. A first end of this double action fastener threads into a traditional adapter or arbor (see FIG. 22), with an opposite second end adapted to secure the cutter disc. In order to prevent the double action fastener from unscrewing or loosening, a top plate or cap attaches to the cutter base and over at least a portion of the double action fastener. With the top plate secured to the base, the second end of the double action fastener is threaded onto the cutter disc. A stop, such as a pin, may be held by the top plate, and prevents over-tightening of the cutter disc onto the double action bolt.

It should be understood that according to embodiments of the present disclosure, an operator is able to remove only the cutter disc from the rest of the shell mill assembly with significant ease (e.g., with one or more hand tools). After removal, the cutter disc may be rotate by 180 degrees (i.e., inverted or flipped) before being reinstalling on the double action fastener and base in order to gain a fresh set of cutting inserts or a new cutting surface. This may be achieved without removing the shell mill arbor from a machine. Likewise, the cutter disc may be removed and replaced entirely, or removed to fit new cutting inserts in the event both sides of the cutter disc have reached the end of their service life, by way of example. In this way, the shell mill according to embodiments of the present disclosure is significantly more cost efficient than those of the prior art. For example, in additional to the saving of down time during operation, a customer has the ability to purchase only new cutter discs of the same or differing types, and reuse the remainder of the above described components (e.g., the fastener, base and top plate) of the assembly.

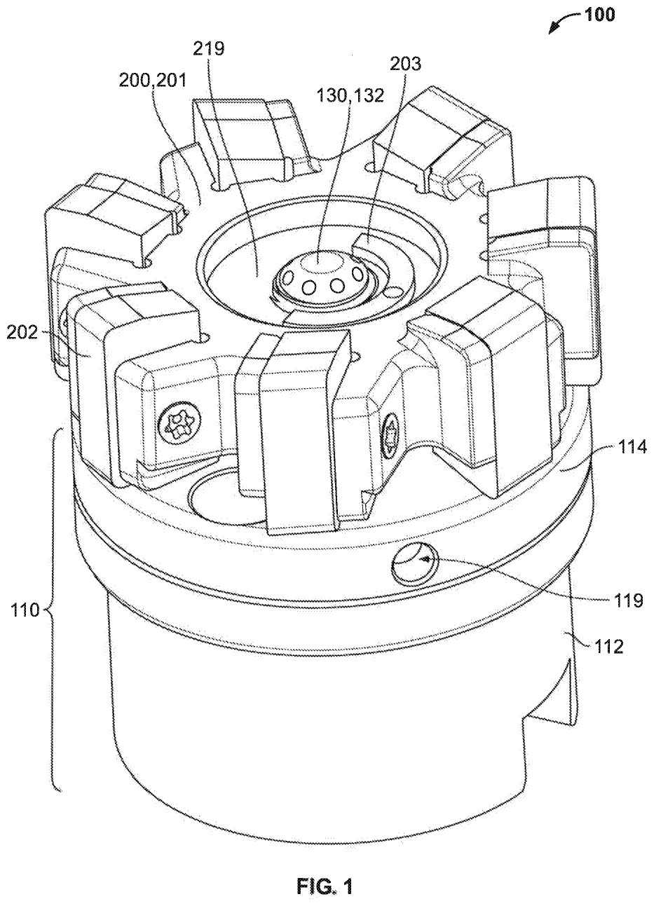

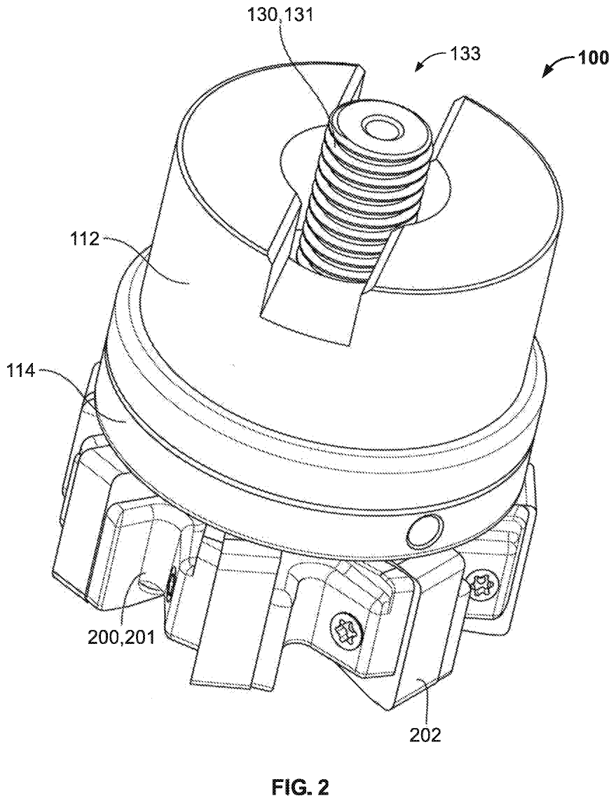

Referring generally to FIGS. 1-3, an assembled view of a tool, and specifically a milling cutter or shell mill 100, according to an embodiment of the present disclosure is shown. The cutter 100 generally comprises a cutter body 110, including a cutter base 112 and a cutter top plate or cover 114, and a removable cutter disc 200. A double action fastener 130 (also referred to as a double action bolt or screw) extends through the cutter body 110 and includes first end threads 131 adapted to threadably engage with a shell mill adapter or arbor (e.g., the threaded opening 410 of the adapter or arbor 400 shown in FIG. 22). The cutter base 112 defines a slot 133 for receiving drive elements of a shell mill adapter or arbor (e.g., drive elements 420 of the arbor 400 of FIG. 22).

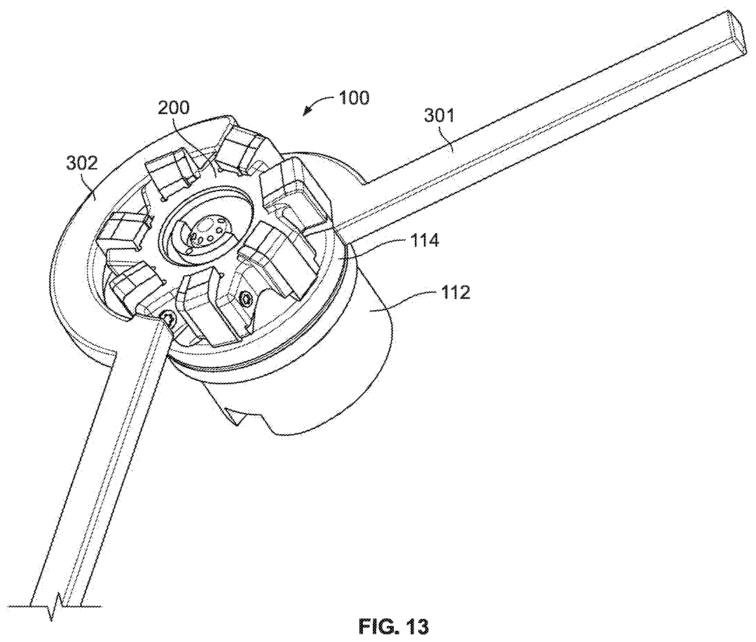

Second end threads 132 of the double action fastener 130 are used to secure the cutter disc 200 to a remainder of the cutter body 110. Further, one or more tool openings 119 may be formed into the cutter top plate 114. In this way, spanners or spanning wrenches 301,302 (see FIG. 13) may be used to remove the cutter disc 200 with its arbor in an installed position on a machine.

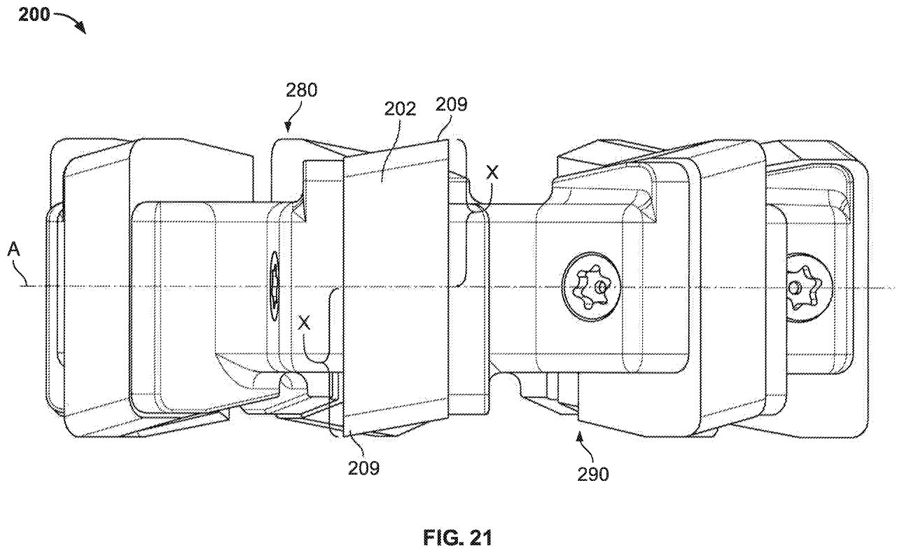

The cutter disc 200 includes a plurality of double sided cutting inserts 202 attached thereto. The cutter disc 200 is adapted to be used in either of a first orientation or position (e.g., as shown in FIG. 1), or a second orientation or position (i.e., inverted or flipped from that shown in FIG. 1). In this way, it should be understood that the cutter disc 200, and specifically a cutting surface defined by the cutting inserts 202, may be identical or near identical on either side such that its cutting operation is unaffected by a change in orientation between the first and second positions. See also the top and bottom cutting sides 280, 290 in FIG. 21. A top of the cutter disc 200 includes a fastening (or unfastening) surface or feature 203, also referred to as a keying feature. In the exemplary cutter disc 200, the fastening feature 203 includes a semicircular protrusion having a locating hole formed therein, and is adapted to receive a complementary working end of a tool, such as a wrench. The fastening feature 203 is operative to permit tightening and loosening of the cutter disc 200 relative to the double action fastener 130 (e.g., for replacement and/or reorientation, as described above).

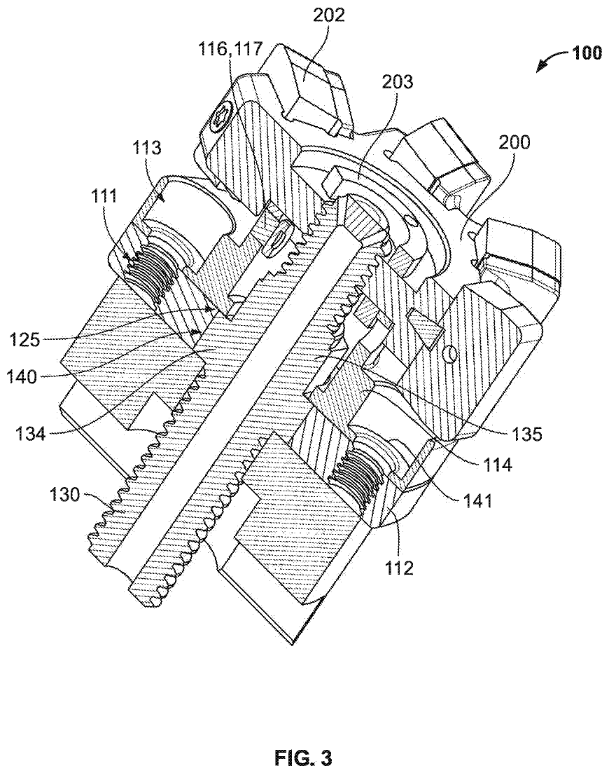

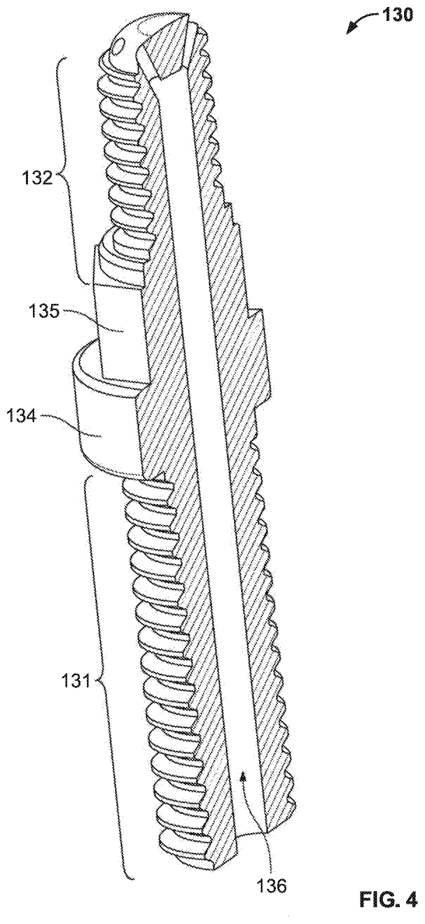

As best shown in FIGS. 3 and 4, the double action fastener 130 may be embodiment as a monolithic or unitary bolt. The fastener 130 includes an elongated body having two ends; a first end defining the first end threads 131, and a second opposite end defining the second end threads 132. The threads 131,132 may or not be the same in pitch and/or diameter. In one embodiment, however, the first end threads 131 are M12×1.75 to mate with shell mill adapters or arbors (see FIG. 22), while the second end threads 132 are M10×1.5 for engaging with the cutter disc 200. Formed or arranged between and separating the threads 131,132 are an annular shoulder 134 (e.g., a cylindrical or flange like protrusion) proximate the first end threads 131, and an integral fastening element 135 adjacent or proximate the second end threads 132. The fastening element 135 may take the form of an integral hex-shape protrusion, such that the double action fastener 130 may be driven to rotate by a standard wrench or socket. The double action fastener 130 may also be hollow, permitting the flow of lubricant or coolant through an internal passage thereof 136 generally from the first end toward the second end during operation.

With particular reference to FIGS. 3, with the double action fastener 130 inserted into a central bore of the cutter base 112, the annular shoulder 134 of the fastener is received in an enlarged coaxial bore 140 of the cutter base. The fastening element 135 remains exposed from a top surface of the cutter base 112 such that it may be engaged to secure the cutter base to the adapter or arbor (e.g., adapter 400). As the cutter top plate 114 is installed (e.g., bolted) over top of the cutter base 112, it covers a portion of the annular shoulder 134 of the double action fastener 130. This overlap can be seen in FIG. 3 in the area identified as 125. See also FIG. 6. Still referring to FIG. 3, the cutter top plate 114 may be secured to the cutter base 112 via a plurality (e.g., four) of counter-sunk fasteners 141. The fasteners 141 are installed within counter sunk bores 113 in the cutter top plate 114 and engage with corresponding threaded holes 111 in the cutter base 112.

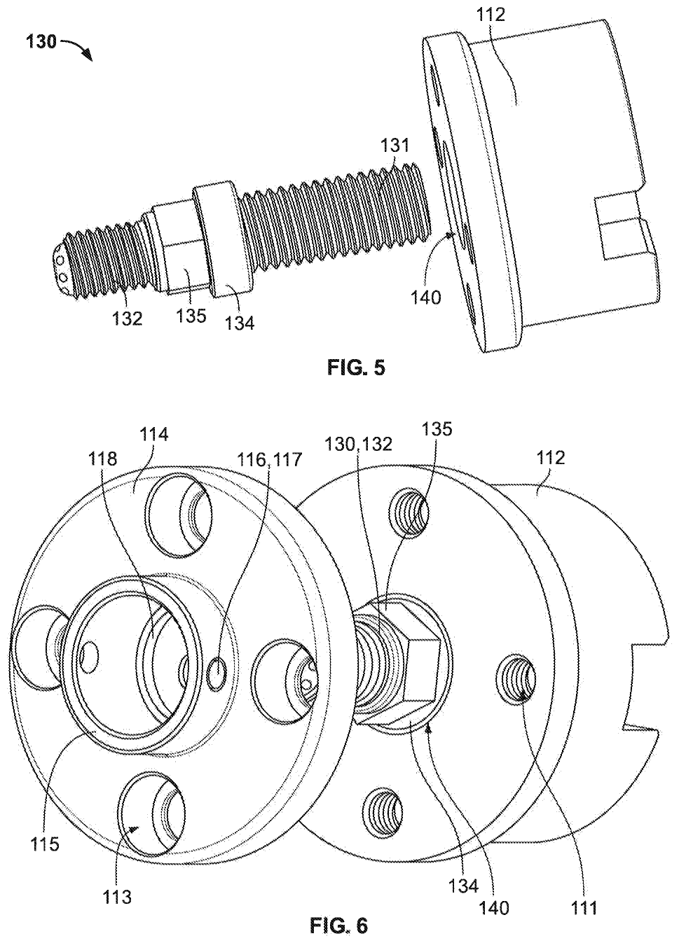

Based on the above description of the cutter 100 of FIGS. 1-4, its assembly and operational functionality will be described with references to FIGS. 5-14. As shown in FIG. 5, in a first step of assembling the cutter 100, the double action fastener 130 is passed through the cutter base 112 (i.e., slid through a central bore thereof). Once inserted, and the annular shoulder 134 seated and bottomed out in the bore 140 (see FIG. 3), the fastening element 135 (e.g., a 13-17 mm hex) may be used to tighten the first end threads 131 of the double action fastener 130 into an adapter or arbor, such as the exemplary adapter 400 of FIG. 22. In this way, the cutter base 112 is fixed to the adapter, and further assembly may proceed.

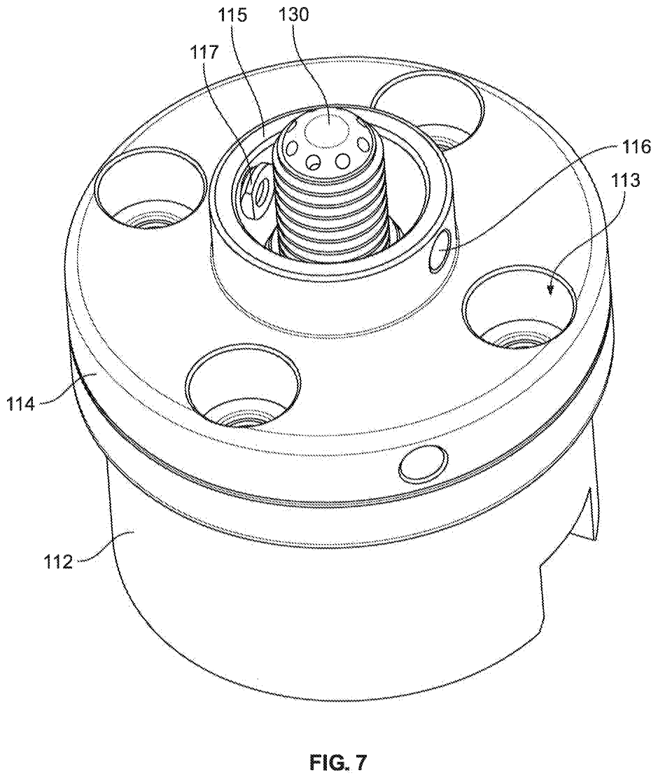

As shown in FIGS. 6 and 7, the cutter top plate 114 is then fitted over cutter base 112. As described above, the cutter top plate 114 secured to the base 112 via a plurality of fasteners (not shown) arranged in the countersunk bores 113 of the cutter top plate 114, and the threaded holes 111 of the cutter base 112. With particular reference to FIG. 6, the cutter top plate 114 defines an annular lip 118 extending radially inward on a bottom thereof. As the cutter top plate 114 is tightened to the cutter base 112, this annular lip 118 abuts the annular shoulder 134 of the double action fastener 130, preventing its rotation and general axial translation, and thus from working lose during operation of the cutter 100.

Still referring to FIGS. 6 and 7, the cutter top plate 114 further includes an axially extending flange 115. The flange 115 includes a plurality of through holes 116 formed therethrough in a radial direction. A pin 117 is arranged in one of the through holes 116. As can be visualized in FIG. 3, the presence of the pin 117 extending into an interior of the flange 115 prevents the cutter disc 200 from being overly tightened during installation. More specifically, in one embodiment, the pin 117 is adapted (i.e., sized and located) to engage with a side of the fastening feature 203 formed on the underside of the cutter disc 200 as it is tightened. In particular, a surface of the feature 203 which faces a direction of tightening of the cutter disc 200 will abut an oppositely facing or opposing lateral side of the pin 117. In the way, the pin 117 is a mechanical stop to the rotation of the cutter disc on the fastener 130.

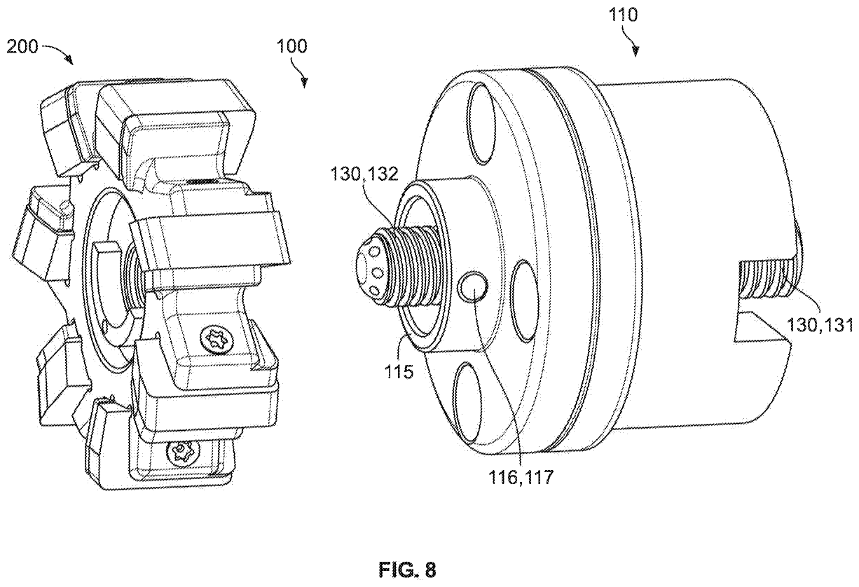

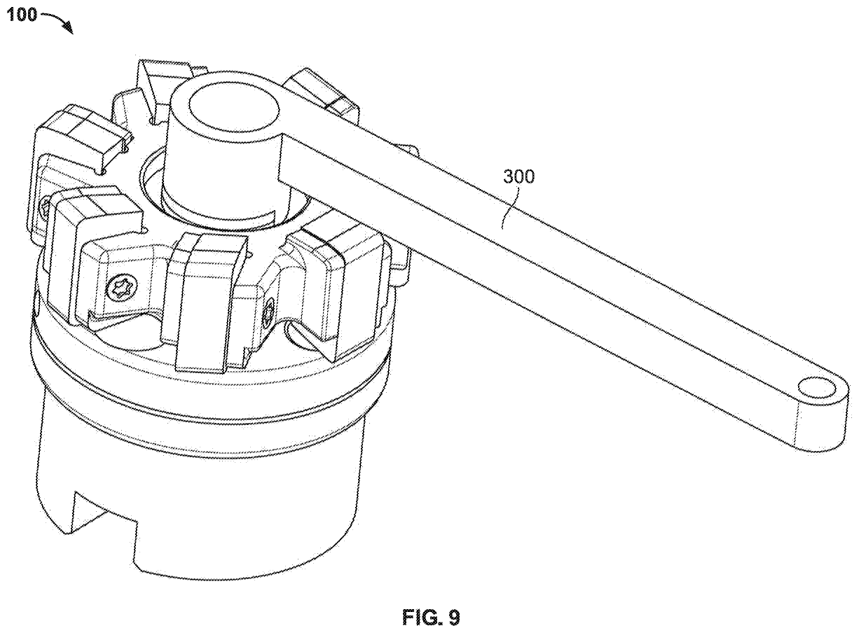

With reference to FIG. 8, once the cutter body 110 is complete, the cutter disc 200 may be installed thereon in the axial direction. Specifically, the cutter disc 200 comprises a threaded central bore complementary to that of the second end threads 132 of the double action fastener 130. As the cutter disc 200 is tightened, an axially facing surface 219 thereof (see FIG. 1) will abut the top of the flange 115, securing the disc to the cutter body 110. This may be achieved by hand, power tool, or via a wrench specifically adapted to fit the fastening surface or feature 203 defined on a body 201 of the cutter disc 200. In one embodiment, as shown in FIG. 9, a wrench 300 is optimally designed to tighten the cutter disc 200 to a desired torque. This may be achieved via any suitable means, such as a traditional integrated break over torque wrench mechanism. In other embodiments, this is achieved by tightening the cutter disc 200 until it engages with the pin 117, preventing its further rotation. According to embodiments, both the fastening feature 203 and the wrench 300 operate in either direction (i.e., tightening the cutter disc onto the dual action fastener, or removing it therefrom).

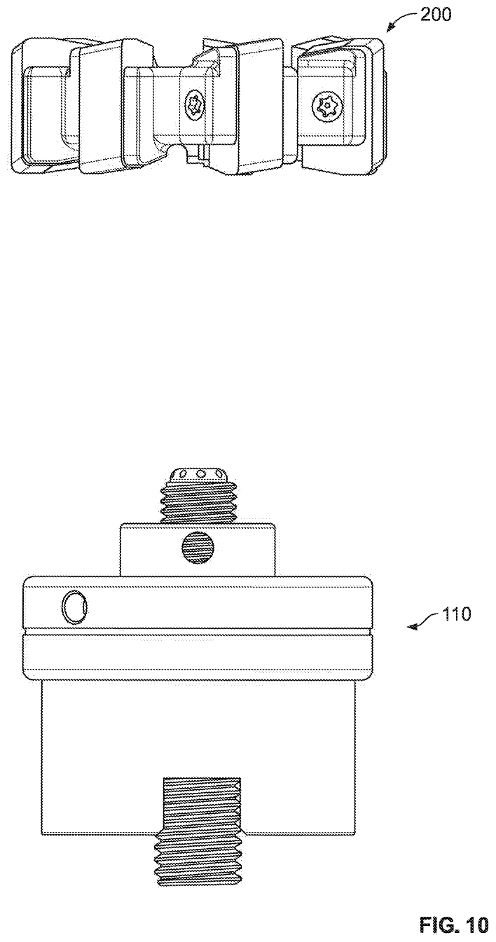

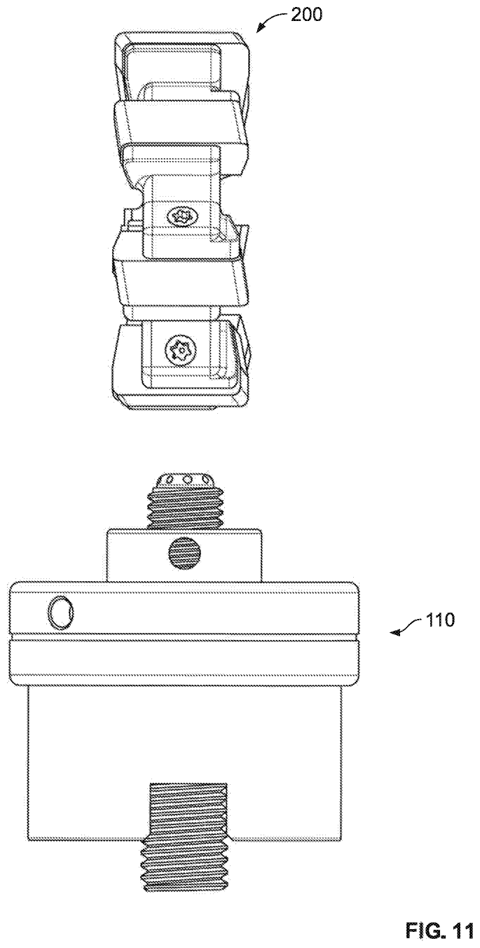

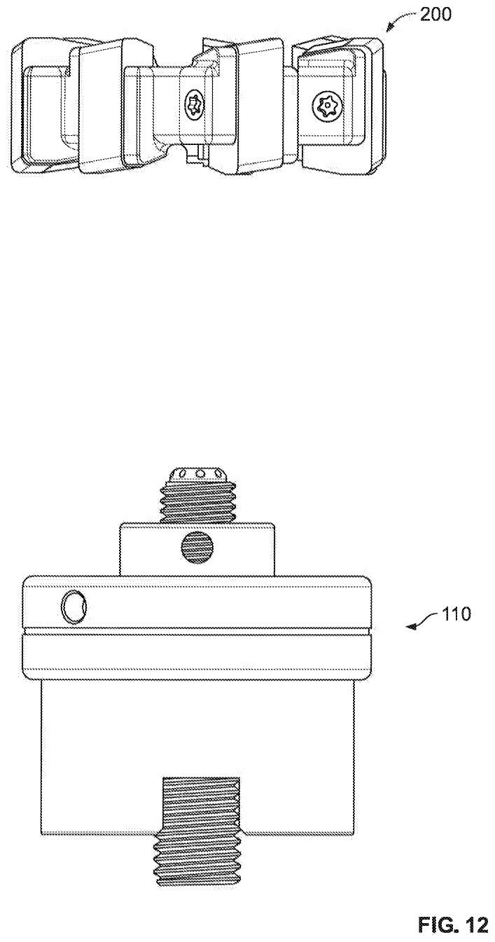

FIGS. 10-12 illustrate a process of removing the cutter disc 200 (FIG. 10) from the cutter body 110, reorienting it (FIG. 11) relative to the body, and realigning it (FIG. 12) for reinstallation onto the body. As this process requires only the removal of the cutter disc 200, it can be done quickly without removing cutter body 110 from the machine. As set forth above, this may be achieved via the dual spanners 301,302 described and shown in FIG. 13, or the single wrench 300 shown in FIG. 9, depending on the application.

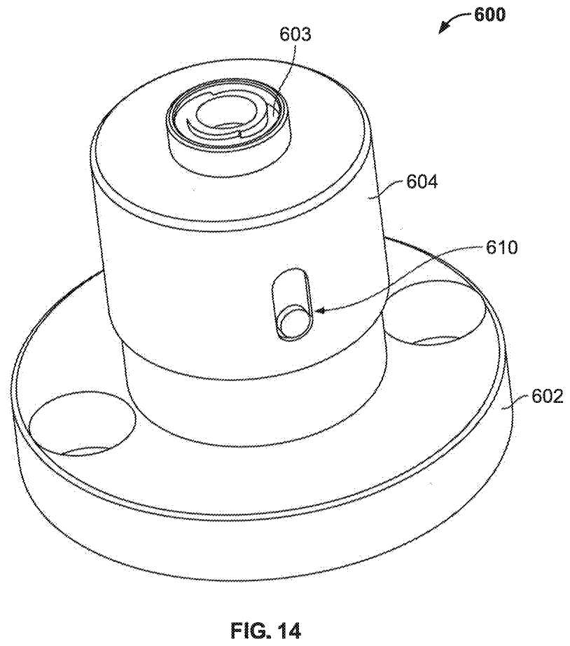

Likewise, referring to FIG. 14, a socket-like adapter or tool 600 defining a complementary mating fastening feature 603 for engaging with the fastening feature 203 of the cutter disc 200 may also be used to remove the cutter disc. The tool 600 may comprise multiple parts, including a base 602 and a cap 604. The cap 604 may be axially translatable relative to the base 602 via the illustrated slot and pin arrangement 610. In one embodiment, an elastic element or spring (not shown) is arranged between the cap 604 and the base 602 and biases the cap away from the base in the axial direction into the position shown. In operation, a downward force on the cap operative to bias the cap toward the base against the elastic return force.

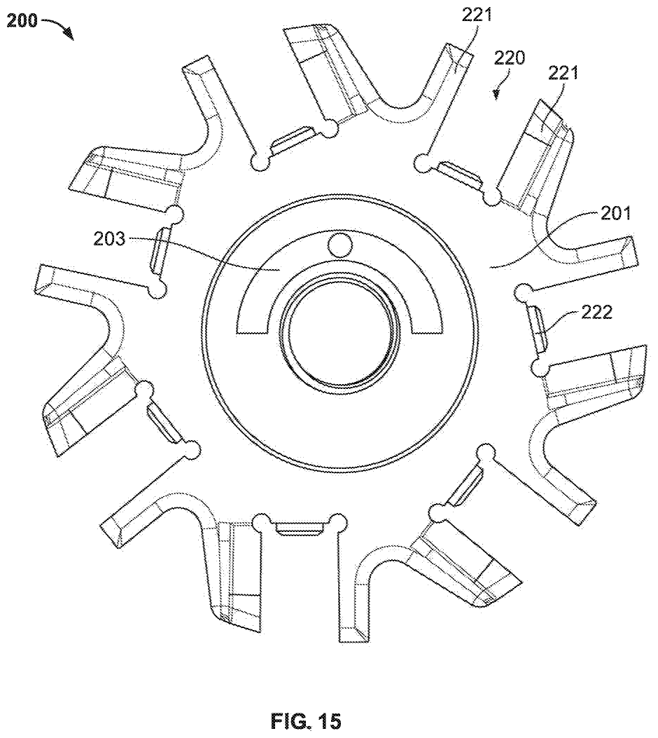

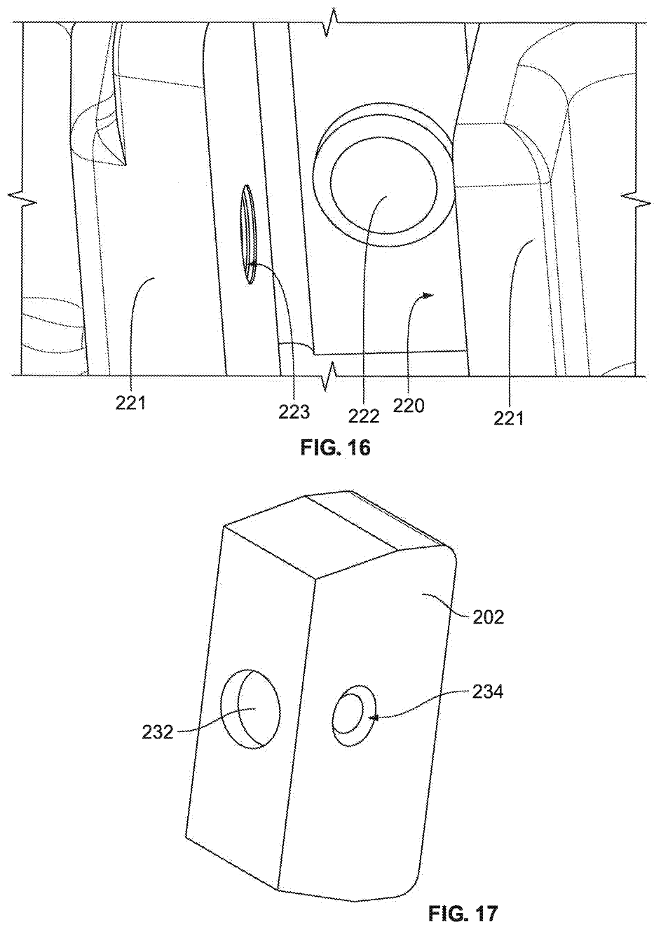

Referring now to FIGS. 15-21, details of the cutter disc 200 and the exemplary cutting inserts 202 are provided. A top (and/or bottom) view of the body 201 of the cutter disc 200 according to the present disclosure is shown in FIG. 15. In addition to the fastening feature 203 and threaded central opening, the body 201 of the cutter disc 200 defines a plurality of pockets 220 adapted to receive a double sided cutting insert 202. More specifically, each pocket 220 is defined by a plurality of generally radially extending walls 221. In one embodiment, opposing faces of each wall 221 defining a given pocket 220 inwardly tapers (e.g., approximately 1 degree) approaching a center of the disc 200. Specifically, when viewed from the top of the disc 200 shown in FIG. 15, each pocket 220 is narrower at its base proximate the center of the disc than at its radially outward opening. This optimally positions and supports the insert 202 within the pocket 220 for use in each of the two directions of operation of the disc 200.

With reference generally to FIGS. 15-17, the body 201 of the cutter disc 200 defines a plurality of locating pins 222 protruding generally radially outward into each of the pockets 220. A threaded fastener hole 223 is also defined through at least one of each pair of walls 221 defining each pocket 220. The pins 222 and holes 223 correspond to respective ones of complementary recesses 232 and holes 234 formed into each insert 202, as shown in FIG. 17.

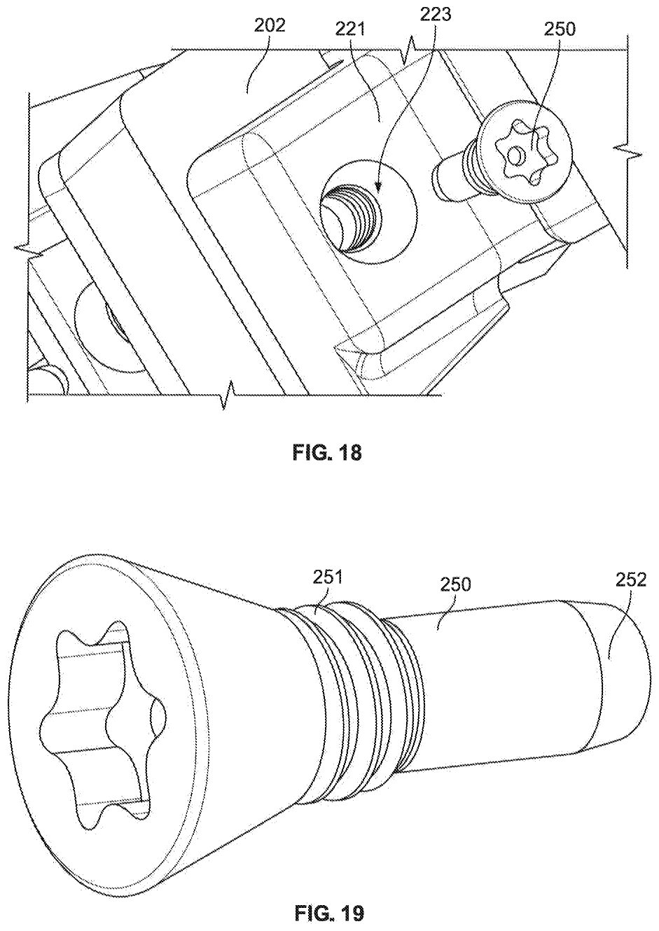

With respect to FIGS. 18 and 19, installation of each insert 202 includes placing the insert into a respective one of the pockets 220, and engaging the recess 232 with the locating pin 222. Next, a threaded pin or screw 250 is installed into the fastener hole 223. Due to the tapered nature of the screw 250, as it is installed into the insert, the insert is drawn further into the pocket as it is securely fixed therein. FIG. 19 provides an exemplary screw 250, including a threading 251 formed only partially down a shank thereof for engaging with the threaded fastener hole 223, as well as a locating tapering tip 252, which engages with the insert 202 before it is fully and or ideally positioned within the pocket 220 and is operative to bias it into a fully seated position as the screw 250 is threaded.

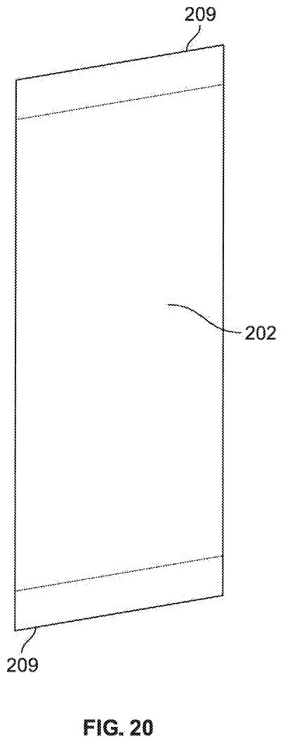

FIG. 20 illustrates the exemplary insert 202. As shown, each opposite cutting edge 209 of the insert 202 are oppositely tapered. In this way, as the cutter disc 200 is reoriented on the cutter body 110, the cutting or spindle rotation direction, remains unchanged. Likewise, FIG. 21 shows the side of the cutter disc 200 with the inserts 202 installed, but prior to installation onto the cutter body 110. When viewed in the same orientation, each of the top and bottom halves of the cutter disc 200 defines an identical cutting surface or cutting side 208, 209. More specifically, the cutting edges 209 of each of the inserts 202 defining a cutting surface on a given side of the disc 200 are arranged at the same distance X from a plane A bisecting the disc. As set forth above, the disc 200 may be identical on each side of the plane A when viewed from the same orientation. This would also include, for example, the duplication of the fastening features 203 on either side of the cutter disc 200.

It should be understood that while the term “cutter” is used herein, other similar terms (e.g., cutting tool, cutting tool assembly, cutter assembly, shell mill, face mill, etc.) may also be used to describe embodiments of the present disclosure. Likewise, other terms may be replaced with suitable equivalents throughout this description (e.g., fastener/bolt/screw), without departing from the scope of the present disclosure.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A shell mill, comprising:
a cutter body adapted to be attached to an arbor; and
a cutter disc removably attachable to the cutter body in each of a first position and a second position, the cutter disc defining:
a first cutting side facing away from the cutter body with the cutter disc in the first position on the cutter body; and
a second cutting side facing away from the cutter body with the cutter disc in the second position on the cutter body.

2. The shell mill of claim 1, wherein the cutter disc includes further a plurality of cutting inserts affixed to the cutter disc, each cutting insert having exposed cutting edges forming a portion of each of the first cutting side and the second cutting side of the cutter disc.

3. The shell mill of claim 2, wherein the plurality of cutting inserts define an identical cutting surface on each of the first and second cutting sides with the cutter disc in respective ones of the first and second positions on the cutter body.

4. The shell mill of claim 1, further comprising a threaded fastener passing through the cutter body and the cutter disc, including:
a first threading adapted to attach the cutter body to the arbor; and
a second threading selectively fixing the cutter disc to the cutter body.

5. The shell mill of claim 4, wherein:
the first threading passes through the cutter body; and
the second threading threadably engages with the cutter disc.

6. The shell mill of claim 4, wherein the cutter body includes:
a cutter base; and
a cutter plate arranged between the cutter base and the cutter disc.

7. The shell mill of claim 6, wherein the cutter plate is fixedly attached to the cutter base.

8. The shell mill of claim 7, wherein the cutter plate fixes an axial position of the threaded fastener relative to the cutter base.

9. The shell mill of claim 8, wherein the threaded fastener defines an annular protrusion secured between the cutter plate and the cutter base.

10. The shell mill of claim 6, wherein the cutter plate limits a threading depth of the cutter disc onto the second threading of the threaded fastener.

11. The shell mill of claim 6, wherein the cutter disc includes a fastening feature adapted to engage with a complementary tool for attaching and detaching the cutter disc from the threaded fastener.

12. The shell mill of claim 11, wherein the cutter plate includes a mechanical stop limiting rotation of the cutter disc on the threaded fastener.

13. A cutting tool, comprising:
a cutter disc including at least one cutting surface on each of a top and a bottom side thereof;
a cutter base adapted to be attached to an arbor for a cutting machine;
a fastener extending through the cutter base and removably securing the cutter disc to the cutter base in each of a first position and a second position exposing a respective one of the top and bottom sides of the cutter disc for use; and
a plate mounted to the cutter base between the cutter base and the cutter disc, the plate fixing a position of the fastener relative to the cutter base.

14. The cutting tool of claim 13, wherein the fastener includes a first end adapted to removably engage with the arbor, and a second end adapted to removably engage with the cutter disc.

15. The cutting tool of claim 14, wherein the fastener includes a drive element formed thereon and adapted to drive the fastener into engagement with the arbor.

16. The cutting tool of claim 15, wherein the fastener further defines an annular protrusion formed thereon, the drive element and the annular protrusion arranged between the first end and the second end of the fastener.

17. The cutting tool of claim 16, wherein:
the cutter base defines a recess receiving the annular protrusion of the fastener; and
the plate covers at least a portion of the annular protrusion arranged within the recess.

18. The cutting tool of claim 17, wherein the cutter disc includes a plurality of cutting inserts, each cutting insert defining cuttings edge forming a portion of the cutting surface of each of the top and bottom sides of the cutter disc.

19. The cutting tool of claim 18, wherein the cutter disc defines a plurality of pockets removably receiving respective ones of the plurality of cutting inserts, each pocket tapering in width in a radially inward direction.

20. The cutting tool of claim 13, wherein the cutter disc includes a fastening surface defined on each of the top and bottom sides thereof and adapted to enable a user install and remove the cutter disc from the fastener with a complementary tool.
